(19) United States
(12) Patent Application Publication
(10) Pub. No.: US 2025/0010724 A1
(43) Pub. Date: Jan. 9, 2025

(54) TRANSPORTATION SYSTEMS

(71) Applicant: Fayçal CHAABI, Giza (EG)

(72) Inventor: Fayçal CHAABI, Giza (EG)

(21) Appl. No.: 18/712,202

(22) PCT Filed: Nov. 28, 2022
(86) PCT No.: PCT/GB2022/053010

§ 371 Date: May 21, 2024

(30) Foreign Application Priority Data
Nov. 29, 2021 (GB) 2117231.7
Feb. 27, 2022 (GB) 2202689.2

(51) Int. Cl. B60L 13/00; B60L 13/03; B60L 13/06

(52) U.S. Cl. CPC B60L 13/003; B60L 13/03; B60L 13/06; B60L 2200/26

(57) ABSTRACT

A transportation system comprising a network of rails (10) connecting a plurality of spaced apart locations (12, 14), plural vehicles running on the network of rails, and plural rail switches (22). Each rail switch (22) guides a vehicle of the plural vehicles from one section (16, 18, 20) of the network of rails to a selected one of at least two further sections (16, 18, 20) of the network of rails or from a selected one of at least two sections (16, 18, 20) of the network of rails to another section (16, 18, 20) of the network of rails, said selection depending on a position of the rail switch. The transportation system further comprises at least one controller (24) configured to control switching of the plural rail switches (22) whereby each of the plural vehicles travels from one of the plurality of spaced apart locations (12, 14) to a selected one of the other of the plurality of spaced apart locations (12, 14). Each of the plural vehicles comprises one of a primary and a secondary of a linear motor. The network of rails (10) comprises the other of the primary and the secondary of the linear motor. The other of the primary and the secondary is distributed in the network of rails (10) whereby the other of the primary and the secondary extends along sections (16, 18, 20) of the network of rails. The one of the primary and the secondary of each vehicle is disposed relative to the other of the primary and the secondary when the vehicle is on the network of rails (10) such that the vehicle is propelled relative to the other of the primary and the secondary when the primary is energised to thereby propel the vehicle through the network of rails.

### FIELD OF THE INVENTION

The present invention relates to systems for transporting one, other or both of persons and cargo by way of plural vehicles.

### BACKGROUND ART

Systems for transporting one, other or both of persons and cargo by way of plural vehicles running on rails are known. Such systems often involve self-propelled vehicles with each vehicle having its own engine or motor which drives wheels of the vehicle whereby the vehicle is propelled along the rails.

The present inventor has recognised that such known transportation systems have shortcomings. The present invention has been devised in the light of the inventor's appreciation of such shortcomings. It is therefore an object for the present invention to provide an improved transportation system for transporting one, other or both of persons and cargo by way of plural vehicles.

### STATEMENT OF INVENTION

According to a first aspect of the present invention there is provided a transportation system comprising:
a network of rails connecting a plurality of spaced apart locations;
plural vehicles running on the network of rails;
plural rail switches each guiding a vehicle of the plural vehicles from one section of the network of rails to a selected one of at least two further sections of the network of rails or from a selected one of at least two sections of the network of rails to another section of the network of rails, selection depending on a position of the rail switch; and
at least one controller configured to control the position of the plural rail switches whereby each of the plural vehicles travels from one of the plurality of spaced apart locations to a selected one of the other of the plurality of spaced apart locations, wherein
each of the plural vehicles comprises one of a primary and a secondary of a linear motor,
the network of rails comprises the other of the primary and the secondary of the linear motor, the other of the primary and the secondary distributed throughout the network of rails whereby the other of the primary and the secondary extends along adjacent sections of the network of rails, and
the one of the primary and the secondary of each vehicle is disposed relative to the other of the primary and the secondary when the vehicle is running on the network of rails such that the vehicle is propelled relative to the other of the primary and the secondary when the primary is energised to thereby propel the vehicle through the network of rails.

The transportation system comprises a network of rails connecting a plurality of spaced apart locations and plural vehicles running on the network of rails. Each of the plural vehicles may be configured to carry one, other or both of persons and cargo. The transportation system further comprises plural rail switches. Each rail switch guides a vehicle of the plural vehicles from one section of the network of rails to a selected one of at least two further sections of the network of rails or from a selected one of at least two sections of the network of rails to another section of the network of rails, selection depending on a position of the rail switch. The transportation system yet further comprises at least one controller configured to control the position of the plural rail switches whereby each of the plural vehicles travels from one of the plurality of spaced apart locations to a selected one of the other of the plurality of spaced apart locations. The transportation system may thus be controlled to provide for navigation of each of the vehicles over the network of rails from a departure location to a selected one of plural destination locations.

Each of the plural vehicles comprises one of a primary and a secondary of a linear motor and the network of rails comprises the other of the primary and the secondary of the linear motor. The other of the primary and the secondary of the linear motor is distributed throughout the network of rails whereby the other of the primary and the secondary extends along adjacent sections of the network of rails. The one of the primary and the secondary of each vehicle is disposed relative to the other of the primary and the secondary, such that the one of the primary and the secondary may oppose and may be spaced apart from the other of the primary and the secondary, when the vehicle is running on the network of rails such that the vehicle is propelled relative to the other of the primary and the secondary when the primary is energised to thereby propel the vehicle through the network of rails. Use of linear motors for propulsion of vehicles through the network of rails may be advantageous over means of propulsion in known transportation systems in respect of one or more of energy efficiency, speed of propulsion along sections of the network of rails, and speed of transit from one section of the network of rails to another section of the network of rails by way of a rail switch.

As discussed above, the transportation system comprises a network of rails. The network of rails connects the plurality of spaced apart locations whereby each of the vehicles may navigate from a departure location to a selected one of plural destination locations. Typically the transportation system may comprise many spaced apart locations with the transportation system often comprising over a hundred spaced apart locations and perhaps over a thousand spaced apart locations. In view of the capability of each of the vehicles to navigate over the network of rails from a departure location to a selected one of the destination locations, the transportation system may comprise many rail switches. The transportation system may therefore comprise at least one cascade of rail switches and typically plural cascades of rail switches. Each of the plural cascades of rail switches may be present in a respective route between a different combination of departure location and destination location. For example, a first cascade of rail switches may be present between a first departure location and a first destination location, and a second cascade of rail switches may be present between a second departure location and a second destination location.

A cascade of rail switches may comprise a plurality of rail switches which are arranged in series. A first rail switch may feed a second rail switch, the second rail switch may feed a third rail switch, the third rail switch may feed a fourth rail switch, etc. Typically, the cascade of rail switches may comprise more than two rail switches and sometimes many more than two rail switches. The rail switches in a cascade of rail switches may be near one another. More specifically, there may be a short section of rail between first and second switches in the cascade. Where the cascade comprises more than two switches, there may be a short section of rail between the second and third switches, and between adjacent further switches, if such further switches are present.

A vehicle may stop at each of the plurality of spaced apart locations. The vehicle may stop for boarding of people where the vehicle is configured to carry people and/or for loading of cargo where the vehicle is configured to carry cargo. Alternatively or in addition, the vehicle may stop for people to alight from the vehicle where the vehicle is configured to carry people and/or for unloading of cargo where the vehicle is configured to carry cargo. The transportation system may be configured accordingly to provide for movement of each vehicle between stopping locations and for stopping of the vehicle at stopping locations.

Movement and stopping of the vehicle may be achieved by respectively energising and de-energising the primary of the linear motor.

Where the primary is comprised in the vehicle, control over energising and de-energising the primary may be exercised from the vehicle whereby each of the plural vehicles is independently controllable concerning movement and stopping. This may simplify the network of rails in respect of control of different parts of the rail network independently of one another. However, power to energise the primary may then need to be provided in the vehicle. At least a part of the power may be provided by an electric battery comprised in the vehicle. Where the linear motor is an AC motor, the vehicle may further comprise an inverter to convert DC power from the electric battery to AC power for the linear motor. The electric battery may be configured for recharging. Recharging of the electric battery may comprise at least one of: recharging from a mains electricity supply when the vehicle is at rest, such as at one of the plural locations; recharging from a source of solar energy comprised in the vehicle, such as at least one solar panel fitted to the roof of the vehicle, when the vehicle is at rest and/or moving; and inductive charging of the electric battery from a power source distributed along rails of the network of rails whereby the electric battery is charged when the vehicle is at rest and/or moving through the network of rails. Where there is inductive charging of the electric battery, the transportation system may further comprise wireless power transfer apparatus configured to transfer electrical power by electromagnetic induction from the power source to the vehicle. Where an electric battery is insufficient for energising the primary or electric battery is absent, the transportation system may comprise a power source distributed along rails of the network of rails and wireless power transfer apparatus configured to transfer electrical power by electromagnetic induction from the power source to the vehicle. Electrical power may thus be provided to the vehicle when the vehicle is at rest and/or moving through the network of rails.

Where the secondary is comprised in the vehicle, it may be advantageous to be able to energise and de-energise the primary of the linear motor in a part only of the network of rails, such as a part having a stopping location. A vehicle may therefore be stopped at the stopping location and without movement of other vehicles being stopped. The transportation system may therefore comprise a plurality of primaries each at a respectively different part of the network of rails. Each of the plurality of spaced apart locations may have a respective primary. More specifically, the respective primary may extend along rail connected to the location to define a part of the network of rails beyond the location per se and within which there is independent control of energising and de-energising the respective primary. Furthermore, other sections of rail may comprise at least one further primary with often plural further primaries being employed to allow for independent control over vehicle propulsion in different areas of the network of rails. Having the secondary comprised in the vehicle may be advantageous over having the primary comprised in the vehicle because all vehicles on a section of rail powered as the same primary will move at substantially the same speed. Having vehicles travelling on a section of rail at substantially the same speed may reduce the risk of a vehicle which is joining the section of rail colliding with vehicles already on the section of rail. Furthermore, there may be less need for control and monitoring of the vehicles to specifically address the risk of collision.

Each of the plurality of spaced apart locations may be a departure location or a destination location. Furthermore, each of the plurality of spaced apart locations may function as both a departure location and a destination location. Each of the plurality of spaced apart locations may be configured accordingly, such as in respect of providing for at least one of boarding of people and people alighting and/or for at least one of loading and unloading of cargo. A location may be configured by way of cargo handling apparatus at the location or by providing for movement of people to and from a vehicle.

Locations of the plurality of spaced apart locations may each be at a respective terminus defined by the network of rails. Furthermore, further locations of the plurality of spaced apart locations may each be at a way location defined by the network of rails. At least two rail sections may be connected at the way location. A vehicle may therefore arrive at the way location on a first rail section and depart from the way location on a second rail section. A terminus location may be at residential or business premises. A way location may be at residential premises with there being perhaps at least one way location and a terminus location in larger residential premises. Similarly, a way location may be at business premises with there being perhaps at least one way location and a terminus location in larger business premises. Alternatively or in addition, a way location may be at a publicly accessible location. The transportation system may have plural spaced apart publicly accessible way locations whereby at least a part of the transportation system is comprised in a mass transit system. Members of the public may thus make use of the transportation system for transporting themselves or for shipment of their cargo.

The linear motor may be a linear switched reluctance motor. The linear switched reluctance motor may be advantageous over other forms of linear motor, such as the linear induction motor and the permanent magnet linear synchronous motor, because of reliability and cost considerations, capability of producing high propulsion force without using permanent magnets, and more fault tolerance because of phase independence.

The linear switched reluctance motor may involve more complex control than the linear induction motor whereby the linear induction motor is preferred. The linear motor may therefore be a linear induction motor.

The transportation system may comprise a gap maintaining device for each of the plural vehicles. The gap maintaining device may be operative to maintain a gap between rail of the rail network and the vehicle whereby the vehicle does not abut against the rail and thereby reduce effectiveness of propulsion by the linear motor.

Electro-dynamic suspension offers the advantage over permanent magnet electro-dynamic suspension of reduced liability to dynamic instability. Liability to dynamic instability may require closer rail tolerances. As discussed above, vehicles travel through the network of rails and in so doing transit by way of plural and perhaps very many rail switches. Closer rail tolerances in the present network of rails may impose significant design, installation and maintenance demands with consequential adverse cost impact. The gap maintaining device may therefore comprise an electro-dynamic suspension arrangement.

As discussed above, vehicles travel through the network of rails between locations of the plurality of locations. Parts of the network of rails may be in areas where high vehicle speed is desired, such as trunk routes, and other parts of the network of rails may be in areas where low vehicle speed is desired, such as parts of the network of rails at or near terminus locations. Parts of the network of rails at or near terminus locations may, for example, be in or near residential or business premises. Electro-dynamic suspension has a disadvantage of not providing levitation until lift-off speed has been reached. Vehicles moving at lower speeds, such as at or near terminus locations, may be moving at speeds lower than lift-off speed whereby the vehicles are liable to abut against the rails of the network of rails. The gap maintaining device may therefore comprise plural spaced apart ground engaging wheels. The gap maintaining device may comprise at least one pair of wheels, the wheels in a pair of wheels disposed at corresponding locations towards or at opposite sides of the vehicle.

The ground engaging wheels may be attached at respective locations on the vehicle and may be sized to maintain a gap between the vehicle and the rail of the network of rails when the ground engaging wheels are ground engaging. Furthermore, the ground engaging wheels may be attached at respective locations on the vehicle and may be sized such that the engaging wheels make substantially no contact with the ground when the electro-dynamic suspension is operative to lift the vehicle.

Providing for substantially no contact with the ground when the electro-dynamic suspension is operative to lift the vehicle may reduce drag on the vehicle which might otherwise impede propulsion of the vehicle when the vehicle has reached lift-off speed, such as when the vehicle is moving on trunk routes of the network of rails.

The transportation system may comprise a navigation system which is operative to determine and perhaps also track the location of each of the plural vehicles. Determining the location of each of the plural vehicles may be needed to control the transportation system. Such control may comprise at least one of: energising and/or de-energising the linear motor; and controlling switching of the plurality of rail switches. Such control may be advantageous to provide for efficient and effective movement of vehicles through the network of rails, and/or address the risk of vehicles colliding when a vehicle transits by way of a rail switch from one section of rail to another section of rail.

The navigation system may comprise a radio navigation system. The radio navigation system may be a satellite-based radio navigation system, such as the Global Positioning System (GPS).

Linear motors can provide for propulsion at high speed, such as speed over 100 km/h up to 500 km/h. A vehicle moving at 500 km/h travels 139 m in one second. An error of a fraction of a second in control of a rail switch and in transit of a vehicle from a first section of rail to a second section of rail, such as from a low speed section of rail to a high speed section of rail in a trunk route, may make the difference between the vehicle transiting safely to the second section of rail and the vehicle colliding with another vehicle which is already on the second section of rail. It may therefore be important to determine the location of vehicles accurately.

Accuracy of a satellite-based radio navigation system can become degraded, such as by signal reflection off nearby higher rise buildings and signal blockage by nearby higher rise buildings. Degradation of accuracy may be addressed by augmenting the satellite-based radio navigation system, such as by use of a dual-frequency satellite-based radio navigation system. Even with such augmentation, radio reception may be lost or degraded, such as when a vehicle is traveling in a tunnel. Likewise, where a radio navigation system other than a satellite-based radio navigation system is used, accuracy of the radio navigation system may be insufficient or may become degraded. Alternatively radio reception may be lost.

Alternatively or in addition, the navigation system may comprise a dead-reckoning navigation system which depends on other than radio reception. The dead-reckoning navigation system may be an inertial navigation system. Where the navigation system comprises a radio navigation system, the navigation system may further comprise the dead-reckoning navigation system. The navigation system may be configured to make selective use of the radio navigation system and the dead-reckoning navigation system. By way of example, the navigation system may select the dead-reckoning navigation system when a level of confidence of location determined by the radio navigation system falls below a threshold, and otherwise may select the radio navigation system.

The inertial navigation system may comprise at least one inertial sensor and more specifically at least one of an accelerometer and a gyroscope. The inertial navigation system may further comprise a magnetometer. In view of the network of rails extending at least primarily in two dimensions, the at least one inertial sensor may be operative in at least two axes. Where the location of a vehicle needs to be known in a third axis, i.e. height above ground, the at least one inertial sensor may be operative in three axes. The inertial navigation system may, for example, comprise a 3-axis accelerometer, a 3-axis gyroscope, and a 3-axis magnetometer. As described further below, extension of rails of the network of rails vertically, such as up and down a high rise building, may involve determining position of a vehicle in the third axis.

Dead-reckoning navigation systems, such as an inertial navigation system, tend to suffer from drift. Drift errors can be corrected by reference to a reference source of location. For example, the radio navigation system disclosed above may function as the reference source of location to correct a drift error. However, and as discussed above, radio reception may be absent or accuracy of the radio navigation system may be degraded whereby the radio navigation system is unable to provide for correction of the drift error.

The reference source of location may be provided with reference to an accurately known location in the network of rails. The transportation system may therefore comprise at least one rail referenced locating device which is operative to provide an accurate location on a rail of the network of rails. The radio navigation system may be configured to correct drift of the dead-reckoning navigation system in dependence on the accurate location provided by the rail referenced locating device.

The rail referenced locating device may comprise a rail component which is at a specific location on the rail and which is encoded with the specific location, such as in the form of coordinates for the specific location. The rail referenced locating device may further comprise a vehicle component which is comprised in a vehicle and which is operative to receive the specific location encoded in the rail component. The vehicle component may be configured to receive the encoded specific location from the rail component wirelessly, such as by way of a radio frequency communication channel.

As discussed above, precision in location determination of vehicles may be important. It may therefore be important that the specific location of the rail component on the rail is in registration with the vehicle component. Distance between the vehicle component and the dead-reckoning navigation system may be known whereby the specific location can be registered with the dead-reckoning navigation system. The rail referenced locating device may therefore be configured to trigger transmission of the encoded specific location from the rail component when a part of the vehicle of known location is substantially aligned with the rail component. The vehicle component may be located at the part of the vehicle of known location.

The rail referenced locating device may comprise a two component proximity sensor, for example an optical proximity sensor, such as an infrared sensor, or a magnetic proximity sensor, such as a Hall effect sensor, with a first component of the proximity sensor comprised in the vehicle component and a second component of the proximity sensor comprised in the rail component. The first and second components of the proximity sensor may be disposed and the proximity sensor may be configured to generate a trigger signal when the first and second components of the proximity sensor are aligned. The rail component may transmit the encoded specific location in dependence on the generated trigger signal.

The rail referenced locating device may comprise a radio frequency identification (RFID) reader and an RFID tag. The RFID reader may be an active RFID reader and may be comprised in the vehicle component. The RFID tag may be comprised in the rail component and may be encoded with the specific location. The trigger signal may be generated by the first component of the proximity sensor and may be received by the active RFID reader whereupon the active RFID reader interrogates the RFID tag to thereby receive the encoded specific location. Drift error of the dead-reckoning navigation system may be corrected in dependence on the received encoded specific location.

A rail component of the rail referenced locating device may be installed at each location in the network of rails where correction of drift error is likely to be needed or indeed where accurate location of a vehicle is needed despite use and proper operation of a radio navigation system. The rail component may be installed at or near each rail switch where accurate control of vehicle transit across the rail switch is needed. Alternatively or in addition, the rail component may be installed in tunnels or partially enclosed spaces where loss of radio signals is likely.

Rails of the network of rails may extend across the ground. Furthermore, rails of the network of rails may extend vertically and substantially solely in a vertical direction, such as up and down a building in residential or business premises. The transportation system may be configured for each of the plural vehicles to move along vertically extending rails of the network of rails as well as along horizontally extending rails of the network of rails.

The transportation system as described thus far may depend on gravity exerting force on each vehicle to maintain a desired gap between the vehicle and the rail and without the gap becoming too large for cooperation between vehicle and rail to be lost. When a vehicle is moving along a vertically extending rail, gravity no longer exerts such a restraining force. The vehicle and the vertically extending rail may therefore define respective profiles which interengage with each other to limit an extent of gap between vehicle and rail while allowing for movement of the vehicle along the rail.

The vehicle may further comprise plural spaced apart vertical running wheels and the rail may define plural recesses, each recess receiving a respective one of the plural vertical running wheels. The plural vertical running wheels may be disposed at spaced apart locations on an end of the vehicle. Furthermore, the rail may define a gap in each of the plural recesses, each of the defined gaps at a height corresponding to a respective one of the plural vertical running wheels when the vehicle is on a horizontally extending rail adjacent the vertically extending rail whereby the plural vertical running wheels are received in their respective recesses and the plural vertical running wheels and recesses interengage when the vehicle moves up from the horizontally extending rail. The vehicle may thus transit from movement along the horizontally extending rail to the vertically extending rail and vice-versa.

Under certain circumstances, the linear motor may generate insufficient force to move the vehicle along the vertically extending rail, such as when heavy cargo is being carried or many passengers are being carried by the vehicle. The vehicle may therefore comprise a gas or liquid fuelled motor which provides supplementary motive force. The gas or liquid fuelled motor may comprise a fuel cell. The gas or liquid fuelled motor may be of wider application when part of the network of rails extends into territory lacking infrastructure to provide electrical power to the linear motor whereby the gas or liquid fuelled motor alone provides motive power to the vehicle.

Sections of the network of rails may comprise plural parallel rails and the plural vehicles may be of different widths and otherwise shaped to run on different selections from the plural parallel rails. One form of vehicle may be narrower and may run on one of the plural parallel rails. Such a form of vehicle may be suited to carrying smaller amounts of cargo on account of its smaller size. Another form of vehicle may be wider and may run on two of the plural parallel rails. Such a form of vehicle may be suited to carrying people on account of its larger size.

The transportation system may further comprise at least one container. Often, the vehicles transportation system may comprise plural containers. Each at least one container may be configured to carry one, other or both of persons and cargo. Each at least one container may be mechanically coupled to one of the plural vehicles whereby the container moves with the vehicle. In one approach, the container may comprise at least one wheel, and more specifically plural spaced apart wheels, which run on rails of the network of rails. Furthermore, the container may be mechanically coupled to the vehicle by a mechanical coupling which may be releasable. The mechanical coupling may be of known form and function. The container may thus be drawn or pushed by the vehicle. Alternatively or in addition, and in a second approach, the container may be attached to the vehicle, such as on top of the vehicle.

The transportation system may comprise a ground supported spacer structure which supports a substantial part of the network of rails. The network of rails may thus be raised up from the ground. The spacer structure may define an elongate aperture therethrough. The aperture may be defined substantially wholly by the spacer structure or may be defined in part by the ground on which the spacer structure is supported and otherwise by the spacer structure.

The transportation system may further comprise electrical cable which extends along the elongate aperture. The electrical cable may provide electrical power to the at least one primary of the linear motor, such as by way of at least one distribution spur. A proximal end of the electrical cable may be electrically coupled to an electrical power source, such as a mains electricity distribution point, an electricity generator, or an electric battery.

The transportation system may further comprise an elongate public utility conveyance which extends along the elongate aperture. The public utility conveyance may comprise at least one conduit which contains and provides for transport of gas or fluid. By way of a first example, the conduit may supply gas to residential and business premises. By way of a second example, the conduit may supply water to residential and business premises. By way of a third example, the conduit may provide for drainage of fluid from residential and business premises. Alternatively or in addition, the public utility conveyance may comprise at least one cable. More specifically, the cable may be electrical cable. By way of a first example, the electrical cable may provide electrical power to residential and business premises. By way of a second example, the electrical cable may provide for transmission of data, such as to and from residential or business premises.

Alternatively or in addition, the cable may be optical cable for transmission of data, such as to and from residential or business premises.

The transportation system may comprise an elongate rail partition structure. The rail partition structure may comprise first to third surfaces which are disposed relative to one another to define a channel. Each of the second and third surfaces may be substantially orthogonal to the first surface. The first surface may support at least one section of the network of rails. Where the transportation system comprises a spacer structure, the first surface may constitute the ground on which the spacer structure is supported. Alternatively, the rail partition structure may be supported on the spacer structure.

The rail partition structure may comprise a fourth surface which is disposed relative to the first to third surfaces to define an enclosed elongate space. The fourth surface may be substantially orthogonal to each of the second and third surfaces. The rail partition structure may be sized such that the plural vehicles travel within and along the enclosed elongate space.

Apparatus disclosed herein, and more specifically electronic apparatus such as the at least one digital processor or the navigation system, may be configured to perform one or more of the processes described herein. The apparatus may comprise structures and/or non-transitory memory having programmed instructions which are operated upon by the apparatus. Alternatively or in addition, the apparatus may comprise electronic circuitry to perform these processes.

The present inventor has appreciated the navigation system to be of wider applicability than hitherto described. Therefore and according to a second aspect of the present invention there is provided a transportation system comprising:
a network of rails connecting a plurality of spaced apart locations;
plural vehicles running on the network of rails, each of the plural vehicles comprising a motor or engine providing motive force which propels the vehicle along rails of the network of rails;
plural rail switches each guiding a vehicle of the plural vehicles from one section of the network of rails to a selected one of at least two further sections of the network of rails or from a selected one of at least two sections of the network of rails to another section of the network of rails, selection depending on a position of the rail switch;
a navigation system operative to determine the location of each of the plural vehicles and provide corresponding location outputs; and
at least one controller configured to control the position of the plural rail switches in dependence on the location outputs from the navigation system, whereby each of the plural vehicles travels from one of the plurality of spaced apart locations to a selected one of the other of the plurality of spaced apart locations.

The transportation system comprise a navigation system which is operative to determine and perhaps also to track the location of each of the plural vehicles. Switching of the plurality of rail switches is controlled in dependence on location outputs from the navigation system. Such control may be advantageous to provide for efficient and effective movement of vehicles through the network of rails, and/or address the risk of vehicles colliding when a vehicle transits by way of a rail switch from one section of rail to another section of rail.

The navigation system may be a radio navigation system and more specifically a satellite-based radio navigation system. The radio navigation system may suffer the disadvantages described above whereby the navigation system may comprise a dead-reckoning navigation system, such as an inertial navigation system.

Motive force to propel the vehicle along rails of the network of rails may be provided by a linear motor, as described above.

Further embodiments of the second aspect of the present invention may comprise one or more features of the first aspect of the present invention.

The present inventor has appreciated the gas or liquid fuelled motor to be of wider applicability than hitherto described. Therefore and according to a third aspect of the present invention there is provided a transportation system comprising:
a network of rails connecting a plurality of spaced apart locations;
plural vehicles running on the network of rails, each of the plural vehicles comprising a gas or liquid fuelled motor providing motive force which propels the vehicle along rails of the network of rails;
plural rail switches each guiding a vehicle of the plural vehicles from one section of the network of rails to a selected one of at least two further sections of the network of rails or from a selected one of at least two sections of the network of rails to another section of the network of rails, selection depending on a position of the rail switch; and
at least one controller configured to control the position of the plural rail switches whereby each of the plural vehicles travels from one of the plurality of spaced apart locations to a selected one of the other of the plurality of spaced apart locations.

The gas or liquid fuelled motor may comprise a fuel cell. Each vehicle may comprise plural spaced apart ground or rail engaging wheels which are driven by the gas or liquid fuelled motor to thereby propel the vehicle relative to the rail. Further embodiments of the third aspect of the present invention may comprise one or more features of the first aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1 is a schematic representation of a network of rails comprised in the transportation system of the invention;

FIG. 2A is a schematic representation of a rail switch of the network of rails of FIG. 1;

FIG. 2B is a schematic representation of a cascade of rail switches in the network of rails of FIG. 1;

FIG. 3 is a representation in cross section of a section of rail of the network of rails of FIG. 1 with a vehicle thereover;

FIG. 4 is a block diagram representation of a vehicle over a section of rail of the network of rails of FIG. 1; and

FIG. 5 is representation of a junction between horizontally and vertically extending sections of rail.

### DESCRIPTION OF EMBODIMENTS

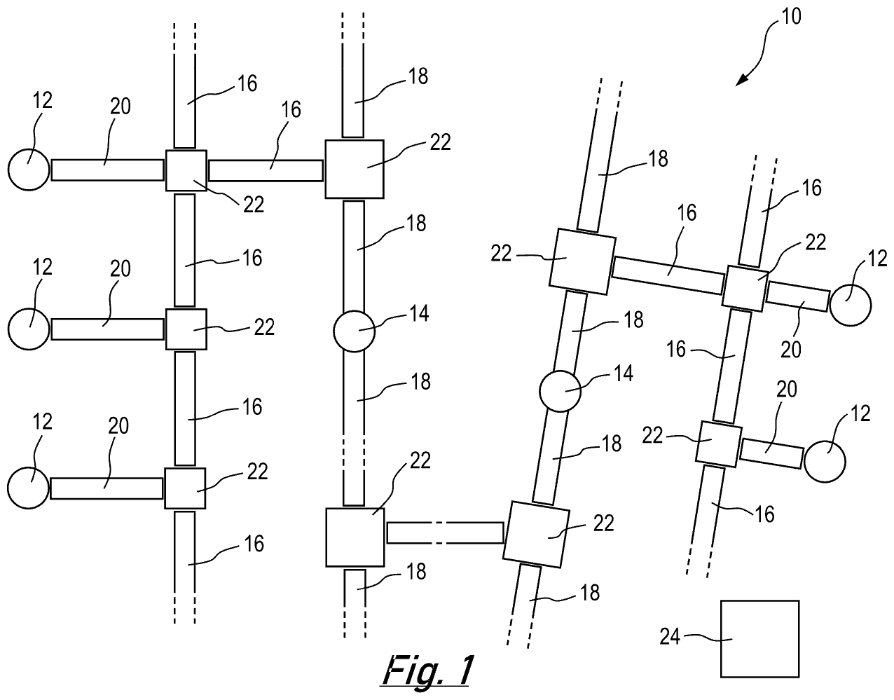

A schematic representation of a network of rails 10 comprised in the transportation system of the invention is shown in FIG. 1. The network of rails 10 extends over considerable territory and typically from one country to another. The network of rails 10 comprises plural spaced apart locations 12, 14. A first form of location 12 is at a terminus of the network of rails 10. The terminus 12 is located in residential or business premises. A second form of location 14 is at a way location within the network of rails 10 and with one set of rails leading to and from the waypoint and at least a second set of rails leading to and from the waypoint to thereby allow a vehicle moving on network of rails to travel in either direction through the way location. The second form of location 14 constitutes a vehicle stopping place for boarding of passengers onto the vehicle and alighting of passengers from the vehicle, and/or loading of cargo onto the vehicle and unloading of cargo from the vehicle.

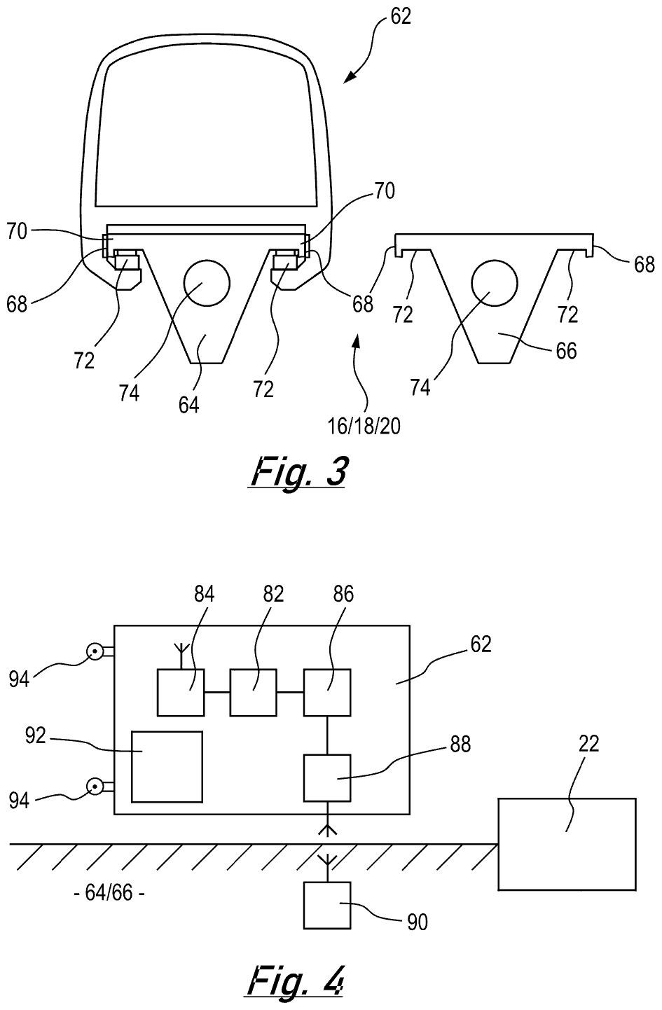

The network of rails 10 further comprises sections of rail 16, 18, 20. A section of rail 16, 18, 20 is described further with reference to FIG. 3. A first form of section of rail 18 is comprised in a trunk route of the network of rails 10. FIG. 1 shows two trunk routes, although in practice a network of rails 10 comprises many such trunk routes. Trunk routes allow for movement of vehicles at higher speeds and typically at more than 250 km/h over long distances, such as from city to city or perhaps from country to country. A second form of section of rail 16 is comprised in a branch route of the network of rails 10. FIG. 1 shows two branch routes, although in practice a network of rails 10 comprises many such branch routes. Branch routes extend over shorter distances and provide for movement of vehicles within the like of a neighbourhood. Vehicles move at medium speed over branch routes and typically between 50 km/h and 250 km/h. A third form of section of rail 20 is comprised in a siding of the network of rails 10. The third form of section of rail 20 provides for vehicle movement between a terminus 12 at a distal end of the third form of section of rail 20 and a branch route at a proximal end of the third form of section of rail. Vehicles move at slow speed on the third form of section of rail 20 and typically at a speed of less than 50 km/h and perhaps much slower than 50 km/h when very low speed manoeuvring of a vehicle is needed. The continuation of the network of rails 10 beyond what is shown in FIG. 1 is indicated by use of dashed lines in sections of rail 16, 18 in branch and trunk routes. A long section of rail 18 in one of the two trunk routes shown in FIG. 1 is shown by way of dashed lines joining solid lines.

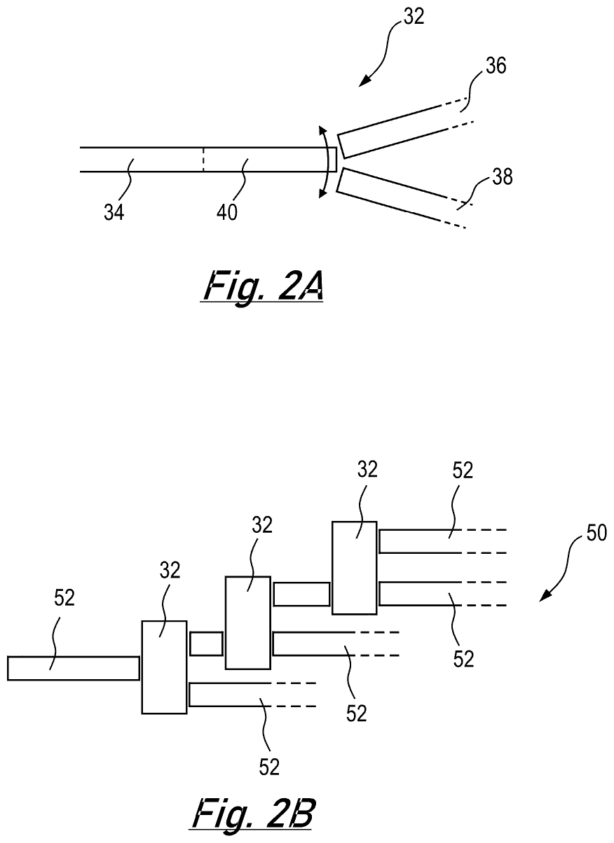

The network of rails 10 further comprises plural rail switches 22 which are described further below with reference to FIGS. 2A and 2B. One or more rail switches 22 are disposed at each of plural locations throughout the network of rails 10. Each one or more rail switches 22 provides for control of transition of a vehicle from one section of rail 16, 18, 20 to a selected one of plural other sections of rail 16, 18, 20. Referring to FIG. 1, rail switches 22 at the proximal end of the third form of section of rail 20 control whether a vehicle transits from the third form of section of rail 20 to a section of rail 16 in a branch route extending in one direction or to a section of rail 16 in a branch route extending in a second, opposite direction. Rail switches 22 also perform a corresponding function in respect of vehicles transiting from a branch route to a trunk route and vice-versa, and from one trunk route to another trunk route and vice-versa. The plural rail switches 22 are thus operated to determine a route taken by a vehicle through the network of rails 10. The transportation system further comprises a controller 24. The controller 24 generates plural control signals which each control a respective one of the plural rail switches 22. The controller 24 is located at a remote central location. In view of the network of rails 10 extending over considerable territory, the controller 24 is constituted in distributed fashion whereby there are in effect plural spaced apart controllers with each controller located in and operative in respect of a respective part of the network of rails 10. Where the controller 24 is constituted in distributed fashion, the controller 24 comprises at least one supervisory controller which provides for coordination of and cooperation between subordinate controllers. In some forms, the controller 24 has a hierarchical architecture with low level controllers each exerting control in a respective neighbourhood, medium level controllers each exerting control over low level controllers in a region comprising plural neighbourhoods, and a high level controller exerting control over the medium level controllers to thereby exert control across the whole network of rails 10.

FIG. 2A is a schematic representation of a rail switch 22, 32 of the network of rails 10 of FIG. 1. The rail switch comprises a first section of rail 34, a second section of rail 36, and a third section of rail 38. A length 40 of the first section of rail 34 which extends from the proximal end of the first section of rail is bendable. The length 40 of the first section of rail 34 is bent by operation of an electromagnetic drive (not shown) between first and second positions. When the length 40 of the first section of rail 34 is bent such that it is in the first position, the distal end of the first section of rail is aligned with the second section of rail 36 whereby a vehicle can transit from the first section of rail to the second section of rail and vice-versa. When the length 40 of the first section of rail 34 is bent such that it is in the second position, the distal end of the first section of rail is aligned with the third section of rail 38 whereby a vehicle can transit from the first section of rail to the third section of rail and vice-versa. The rail switch 34 of FIG. 2A is present where there are three sections of rail each leading to and from the switching location and as shown in respect of all but two of the switching locations in FIG. 1.

Where there are more than three sections of rail each leading to and from a switching location a cascade of switches is used. FIG. 1 shows two switching locations involving four sections of rail with a cascade of two switches present at each of these two switching locations. Although not shown in FIG. 1, the network of rails 10 has switching locations at which there is switching amongst more than four sections of rail. A cascade 50 of three switches 32 is shown in FIG. 2B. The three switches 32 of FIG. 2B are arranged in series whereby a vehicle transits from one switch to the next switch whereby the route of the vehicle is between two of five sections of line 52 each leading to and from the cascade 50.

A representation in cross section of a section of rail 16, 18, 20 of the network of rails 10 of FIG. 1 is shown in FIG. 3. The representation of FIG. 3 also shows a vehicle 62 supported over the section of rail 16, 18, 20. The section of rail 16, 18, 20 comprises two parallel lengths of rail 64, 66. Each of the two lengths of rail comprises a primary 68 of a linear switched reluctance motor disposed towards the top of outer edges thereof. The vehicle 62 comprises a secondary 70 of the linear switched reluctance motor on the underside of the vehicle and located on the vehicle such that it opposes the primary 68 of the linear switched reluctance motor. When the primary 68 is energised by an electrical supply, the primary 68 cooperates electromagnetically with the secondary 70 to propel the vehicle 62 along the length of rail 64. The vehicle 62 and each of the two rails 64, 66 also comprise an electrodynamic suspension system 72 which is operative to lift the vehicle off the rail and to maintain a gap between the vehicle and rail 64, 66. As can be seen from FIG. 3, the vehicle 62 straddles a first one 64 of the two rails 64, 66. The vehicle 62 of FIG. 3 is suitable for carrying a smaller volume of cargo. In an unillustrated form, the vehicle 62 shown in FIG. 3 is wider such that it straddles both rails 64, 66 with the linear switched reluctance motor being constituted by the parts of the primary 68 on the outer edge of each of the two rails 64, 66 and the electrodynamic suspension system 72 is constituted by the parts of the electrodynamic suspension system on towards the outer edge of each of the two rails 64, 66. The unillustrated wider vehicle is suitable for carrying a larger volume of cargo or passengers.

Although not shown in FIG. 3, the vehicle 62 has two pairs of wheels with each pair of wheels mounted on an axle. The wheels are mounted on the vehicle and of such dimensions that they engage the ground and provide minimal clearance between the vehicle 62 and the rail 64, 66 when the vehicle is stationary or moving at less than take-off speed of the electrodynamic suspension system 72. When operation of the linear switched reluctance motor has increased the speed of the vehicle to above the take-off speed, clearance between the vehicle 62 and the rail 64, 66 increases whereby the wheels are no longer ground engaging.

Each of the two rails 64, 66 shown in FIG. 3 has a bore 74 (which constitutes an elongate aperture) extending longitudinally therethrough. The bore 74 accommodates an electrical cable for providing electrical power to the primary 68 of the linear switched reluctance motor. Further to this, the bore 74 accommodates conduits and cables of public utilities to thereby consolidate the location of such conduits and cables. The conduits supply gas to residential and business premises, supply water to residential and business premises, and drain fluid from residential and business premises. The cables comprise electrical cables which provide electrical power to residential and business premises and transmit data to and from residential or business premises, and optical cables which transmit data to and from residential or business premises.

A block diagram representation of the vehicle 62 of FIG. 3 over a section of rail is shown in FIG. 4. The vehicle 62 contains a GPS receiver 82 which is operative to determine and track the location of the vehicle. The vehicle 62 also contains a radio transceiver 84 which is operative to transmit the location of the vehicle to the controller 24 of FIG. 1 for controlling rail switches and/or rail switch cascades 22. The vehicle further contains an inertial navigation system (INS) 86 which is operative to track the location of the vehicle. The INS 86 functions as a back up to the GPS receiver 82 in event of loss or degradation of the GPS signal received by the GPS receiver. A proximity sensor is constituted by a first part 88 contained in the vehicle and a second part 90 attached at a precisely known location on the rail 64/66. The proximity sensor is an optical proximity sensor, such as an infrared sensor, or a magnetic proximity sensor, such as a Hall effect sensor. When the first and second parts of the proximity sensor are aligned, the first part 88 generates a trigger signal. An active RFID reader is contained in the vehicle along with the first part 88 of the proximity sensor and an RFID tag is attached to the rail 64/66 along with the second part 90 of the proximity sensor. The RFID tag is encoded with the precise location of the second part 90 of the proximity sensor. The trigger signal is received by the active RFID reader whereupon the RFID reader interrogates the RFID tag and in return wirelessly receives the encoded precise location from the RFID tag. The received encoded precise location is applied to correct whatever drift error the INS 86 might have accumulated.

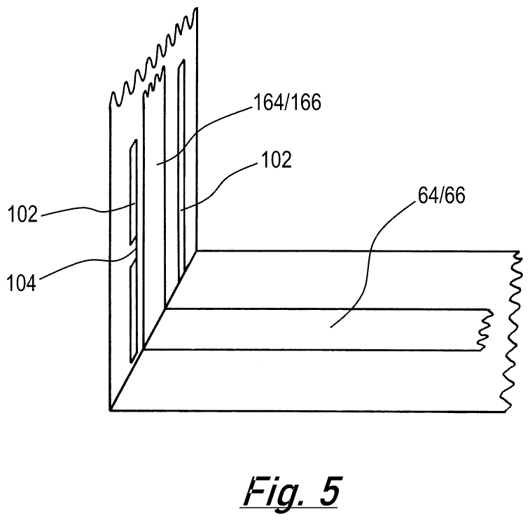

As can be seen from FIG. 4, the vehicle also contains a fuel cell 92 and a motor (not shown) which is driven by the fuel cell. The fuel cell 92 and motor are operative when the vehicle is in a part of the network of rails lacking infrastructure to provide for electromagnetic propulsion by way of the linear switched reluctance motor. The electrodynamic suspension system 72 is therefore inoperative whereby the ground engaging wheels of the vehicle 62 engage the ground. The ground engaging wheels are driven by the motor in dependence on power supplied by the fuel cell 92. The fuel cell 92 and motor find further use when the vehicle is moving along a vertically extending rail as is described below with reference to FIG. 5.

Although not shown in FIG. 4, a container can be attached to the roof of the vehicle 62 to provide additional space for carriage of persons and/or cargo. Alternatively or in addition, and to provide additional space, a container with rail engaging wheels is drawn or pushed by the vehicle 62. The container with rail engaging wheels is coupled to the vehicle 62 by a releasable mechanical coupling of known form and function.

Parts of the network of rails 10 of the transportation system are accommodated in an elongate rail partition structure. An elongate rail partition structure is present where the respective part of the network of rails 10 is underground or when it is desired to shield the part of the network of rails, such as from view or to provide for security. The rail partition structure comprises first to third surfaces with each of the second and third surfaces substantially orthogonal to the first surface to thereby define a channel. The rails 64/66 are supported on the first surface of the rail partition structure. The rail partition structure further comprise a fourth surface which is substantially orthogonal to each of the second and third surfaces whereby the first to fourth surfaces define an enclosed elongate space. The rail partition structure is thus structured and is sized such that vehicles travel within and along the enclosed elongate space defined by the rail partition structure. The rail partition structure is 1.3 to 1.5 m wide and is 1.3 to 1.5 m high. The rail partition structure is therefore of sufficient size to accommodate plural smaller cargo carrying vehicles 62 at the same time and at the same location along the elongate space defined by the rail partition structure. Further to this, the rail partition structure is of sufficient size to accommodate one people carrying vehicle 62 at any time and at the same location along the elongate space defined by the rail partition structure.

FIG. 5 shows the horizontal section of rail 64, 66 of FIG. 4 schematically along with schematic representation of a vertical section of rail 164, 166. The vehicle of FIG. 4 is not shown in FIG. 5. The vertical section of rail 164, 166 operates in the same fashion as the horizontal section of rail 64, 66 in respect of propulsion by the linear switched reluctance motor and in respect of repulsion by the electrodynamic suspension system. However, the change in effective direction of gravity vis-à-vis the rail reduces the effectiveness of the linear switched reluctance motor. The fuel cell 92 and the motor are therefore used as a supplementary source of power to drive ancillary wheels 94 mounted on the side of the vehicle shown in FIG. 4. The ancillary wheels 94 abut against part of the vertical section of rail 164, 166 to thereby provide traction. A further consequence of the effective change in direction of gravity vis-à-vis the rail is a tendency for the vehicle 62 to fall away from the vertical section of rail 164, 166. The vertical section of rail 164, 166 therefore comprises two parallel channels 102 which extend up the vertical section of rail. Each of the two parallel channels 102 receives and interlocks with a respective ancillary wheel 94 to restrict the extent to which the vehicle 62 may move away from the vertical section of rail 164, 166. The ancillary wheels 94 are brought into interlocking cooperation with the channels 102 by way of openings 104 in each channel which are at heights on the vertical section of rail 164, 166 corresponding to heights of the respective ancillary wheels 94 when the vehicle is stationary over the horizontal section of rail 64, 66.

1. A transportation system comprising:
a network of rails connecting a plurality of spaced apart locations;
plural vehicles running on the network of rails;
plural rail switches each guiding a vehicle of the plural vehicles from one section of the network of rails to a selected one of at least two further sections of the network of rails or from a selected one of at least two sections of the network of rails to another section of the network of rails, said selection depending on a position of the rail switch; and
at least one controller configured to control switching of the plural rail switches whereby each of the plural vehicles travels from one of the plurality of spaced apart locations to a selected one of the other of the plurality of spaced apart locations, wherein
each of the plural vehicles comprises one of a primary and a secondary of a linear motor,
the network of rails comprises the other of the primary and the secondary of the linear motor, the other of the primary and the secondary distributed in the network of rails whereby the other of the primary and the secondary extends along sections of the network of rails, and
the one of the primary and the secondary of each vehicle is disposed relative to the other of the primary and the secondary when the vehicle is on the network of rails such that the vehicle is propelled relative to the other of the primary and the secondary when the primary is energised to thereby propel the vehicle through the network of rails.

2. The transportation system according to claim 1 further comprising at least one cascade of rail switches, each cascade of rail switches comprising a plurality of rail switches arranged in series, the plurality of rail switches in the cascade near one another.

3. The transportation system according to claim 1 configured to provide for movement of each of the plural vehicles between stopping locations and for stopping of the vehicle at stopping locations, movement and stopping of the vehicle achieved respectively by energising and de-energising the primary of the linear motor.

4. The transportation system according to claim 3 and where the primary is comprised in each of the plural vehicles, in which control over energising and de-energising the primary is from the vehicle whereby each of the plural vehicles is independently controllable concerning movement and stopping.

5. The transportation system according to claim 4, in which at least a part of electrical power to energise the primary is from an electric battery comprised in the vehicle.

6. The transportation system according to claim 5, and where the linear motor is an AC motor, in which the vehicle further comprises an inverter to convert DC power from the electric battery to AC power for the linear motor.

7. The transportation system according to claim 5 or 6, in which the electric battery is configured for recharging, recharging of the electric battery comprising at least one of: recharging from a mains electricity supply when the vehicle is stationary; recharging from a source of solar energy comprised in the vehicle; and inductive charging of the electric battery from a power source distributed along rails of the network of rails.

8. The transportation system according to claim 3, and where the secondary is comprised in each of the plural vehicles, further comprising a plurality of primaries each at a respectively different part of the network of rails, each of the plurality of primaries selectively energised and de-energised whereby at least one vehicle at each part of the network of rails can be stopped without stopping at least one vehicle in each of at least one other part of the network of rails.

9. The transportation system according to claim 1, in which the linear motor is a linear switched reluctance motor.

10. The transportation system according to claim 1, in which the linear motor is a linear induction motor.

11. The transportation system according to claim 1, further comprising a gap maintaining device for each of the plural vehicles, the gap maintaining device operative to maintain a gap between rail of the rail network and the vehicle whereby the vehicle does not abut against the rail.

12. The transportation system according to claim 11, in which the gap maintaining device comprises an electro-dynamic suspension arrangement.

13. The transportation system according to claim 12, in which the gap maintaining device further comprises plural spaced apart ground engaging wheels which are sized to maintain a gap between rail of the rail network and the vehicle when the ground engaging wheels abut against the ground, and which are sized not to abut against the ground when the electro-dynamic suspension is operative.

14. The transportation system according to claim 1, further comprising a navigation system which is operative to determine the location of each of the plural vehicles, the transportation system controlled in dependence on determined vehicle locations in respect of at least one of: energising and/or de-energising each linear motor; and controlling switching of the plurality of rail switches, wherein the navigation system comprises a radio navigation system.

15. (canceled)

16. The transportation system according to claim 14, in which the navigation system further comprises a dead-reckoning navigation system which depends on other than radio reception, the navigation system making selective use of the radio navigation system and the dead-reckoning navigation system depending on a level of confidence of vehicle location determined by the radio navigation system.

17. The transportation system according to claim 16 further comprising at least one rail referenced locating device which is operative to provide an accurate location in the network of rails, the navigation system correcting drift of the dead-reckoning navigation system in dependence on the accurate location provided by the rail referenced locating device.

18. The transportation system according to claim 17, in which the rail referenced locating device comprises a rail component and a vehicle component, the rail component is at a specific location on a rail and which is encoded with the specific location, and the vehicle component is comprised in the vehicle and is operative to receive from the rail component the specific location encoded in the rail component.

19. The transportation system according to claim 18, in which the rail referenced locating device is configured to trigger transmission of the encoded specific location from the rail component when a part of the vehicle of known location within the vehicle is substantially aligned with the rail component.

20. The transportation system according to claim 1, in which rails of the network of rails extend horizontally across the ground, and rails of the network of rails extend vertically above the ground, the transportation system configured for each of the plural vehicles to move along horizontally and vertically extending rails of the network of rails.

21. The transportation system according to claim 20, in which the vehicle and a vertically extending rail define respective profiles which interengage with each other to limit an extent of gap between the vehicle and the vertically extending rail while allowing for movement of the vehicle along the vertically extending rail.

22. (canceled)

23. (canceled)
